(19) United States
(12) Patent Application Publication
(10) Pub. No.: US 2007/0019215 A1
(43) Pub. Date: Jan. 25, 2007

(54) Image Forming System, Image Forming Apparatus, And Data Processing Method

(75) Inventor: Kazutoshi Yu, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/383,991

(22) Filed: May 18, 2006

(30) Foreign Application Priority Data
Jul. 22, 2005 (JP) 2005-213526

(51) Int. Cl. G06K 15/22

(52) U.S. Cl. 358/1.3

(57) ABSTRACT

An image forming system of the present invention includes an image forming apparatus and a mobile terminal. The image forming apparatus includes: a converter for converting into image data setting information related to job execution; and an output unit for outputting the image data obtained by the conversion. The mobile terminal includes: a photographing unit for photographing the outputted image data; a storage unit for saving the photographed image data; and an output unit capable of outputting either one of the saved image data and setting information indicated by the image data.

This application claims priority under 35 U.S.C. § 119 to Japanese Patent Application No. 2005-213526 filed on Jul. 22, 2005, the entire disclosure of which is incorporated herein by reference in its entirety.

### BACKGROUND OF THE INVENTION

1. Field of the Invention

The present invention relates to an image forming system provided with a mobile terminal such as a mobile phone or the like and an image forming apparatus, to an image forming apparatus for use in this system, and to a data processing method.

2. Description of the Related Art

The following description sets forth the inventor's knowledge of related art and problems therein and should not be construed as an admission of knowledge in the prior art.

To execute a job in the image forming apparatus, a user needs to make various settings. However, following an increase in the number of functions available, the settings to be made have been becoming more complicated, as is the case with a digital composite machine (MFP representing Multi Function Peripherals).

Japanese Unexamined Patent Publication No. H11-338313 discloses an image forming apparatus provided with a program registration function as a conventional function of registering in advance such settings for job execution.

However, even when setting information is saved by such a program registration function, a change or an addition may be made to the setting contents at the time of actual job execution. Thus, registering such a change or an addition has been bothersome.

Moreover, when using an image forming apparatus installed at an irregular location, a shop, or the like, it is practically difficult to register setting information in the program. In this case, therefore, settings need to be made on the image forming apparatus through manual input for every usage, which is not excellent in operability.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide an image forming system that, even when a change or an addition is made to setting contents registered in a program, dose not require re-registration of setting information into the program, and that also does not require settings to be made on an image forming apparatus through manual inputting for every usage.

Among other potential advantages, some embodiments can provide an image forming apparatus preferably used in the system.

Among other potential advantages, some embodiments can provide a data processing method performed in the system.

According to a first aspect of the preferred embodiment of the present invention, an image forming system comprising an image forming apparatus and a mobile terminal,

wherein the image forming apparatus comprises: a converter for converting into image data setting information related to job execution; and an output unit for outputting the image data obtained by the conversion; and

wherein the mobile terminal comprises: a photographing unit for photographing the outputted image data; a storage unit for saving the photographed image data; and an output unit capable of outputting either one of the saved image data and setting information indicated by the image data.

According to a second aspect of the preferred embodiment of the present invention, an image forming apparatus comprising: a converter for converting into image data setting information related to job execution; and an output unit for outputting the converted image data.

According to a third aspect of the preferred embodiment of the present invention, an image forming apparatus comprising:

a reading unit for reading image data that includes setting information related to job execution and that is outputted from a mobile terminal;

an analyzer for analyzing the read image data and extracting setting information; and

a job executor for executing a job based on the extracted setting information.

According to a fourth aspect of the preferred embodiment of the invention, a data processing method comprising the steps of:

converting setting information related to job execution into image data by an image forming apparatus;

outputting the converted image data from the image forming apparatus;

photographing the outputted image data by a mobile terminal;

saving the photographed image data by the mobile terminal;

outputting either one of the saved image data and setting information indicated by the image data from the mobile terminal;

receiving either one of the outputted image data and the setting information by the image forming apparatus; and

executing a job based on either one of setting information extracted by analyzing the received image data and the received setting information by the image forming apparatus.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram of an image forming system according to one embodiment of the present invention;

FIG. 2 is a functional block diagram showing main units of an image forming apparatus of the invention;

FIG. 3 is a functional block diagram showing main units of a mobile terminal of the invention;

FIG. 4 is a plan view showing an operation panel of the image forming apparatus, with a QR code being displayed thereon;

FIG. 5 is a flowchart showing operation according to one embodiment of the invention;

FIG. 6 is a flowchart showing operation according to another embodiment of the invention; and

FIG. 7 is a flowchart showing operation according to still another embodiment of the invention.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

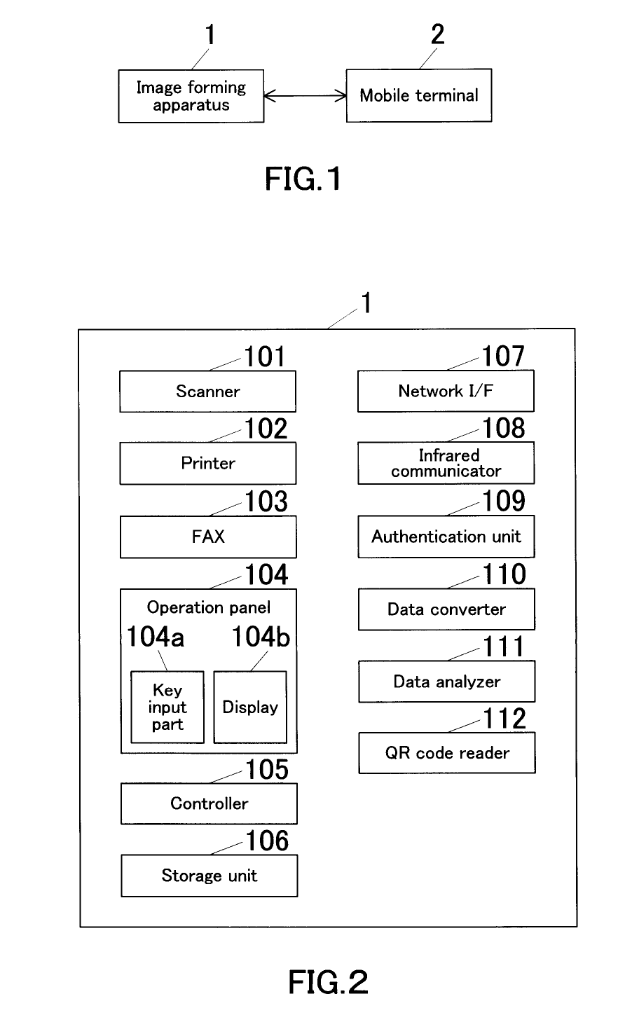

FIG. 1 is a block diagram of an image forming system according to one embodiment of the present invention.

This image forming system includes an image forming apparatus 1 and a mobile terminal 2.

In this embodiment, used as this image forming apparatus 1 is an MFP (Multi Function Peripherals) serving as a digital composite machine which has a print function, a copy function, a facsimile function, and a scanner function.

FIG. 2 shows the functional structure of the main units of the image forming apparatus 1. This image forming apparatus 1 includes: a scanner 101, a printer 102, a facsimile (also referred to as “FAX”) 103, an operation panel 104, a controller 105, a storage unit 106, a network interface (interface is indicated as I/F in the drawings) 107, an infrared communicator 108, an authentication unit 109, a data converter 110, a data analyzer 111, a QR code reader 112, and the like.

The scanner 101 scans a document and converts the scanned document into image data.

The printer 102 prints image data of a document scanned by the scanner 101, print data transmitted from an external apparatus, image data⁽³⁾ saved in the storage unit 106, and the like.

The FAX 103 performs facsimile transmission of image data scanned by the scanner 101 and image data stored in the storage unit 106, and also performs facsimile reception of image data transmitted from an external apparatus.

The operation panel 104 includes: a key input part 104a including ten keys, a start key, and the like; and a display 104b of a touch-panel type made of liquid crystal or the like. The operation panel 104 permits a user to make various inputs thereon, and displays the condition of the apparatus, an operation screen, and the like. In this embodiment, as described below, setting information set by the user upon job execution is converted into a QR code as image data, and then this QR code obtained through the conversion is displayed on the display 104b.

The controller 105 comprehensively controls the entire image forming apparatus 1, makes various determinations, and includes a CPU and memories such as a ROM, a RAM, and the like. The memories include a written program for CPU operation and temporarily store setting information set by the user upon job execution.

The storage unit 106 is composed of, for example, a hard disc, and stores image data and authentication information required for user authentication.

The network interface 107 enables data transmission and reception between the image forming apparatus 1 and a personal computer or the like provided externally.

The infrared communicator 108 enables data transmission and reception to and from the mobile terminal 2 through infrared data communication.

The authentication unit 109 performs user authentication by checking authentication information inputted by the user through the operation panel 104, or authentication information included in a QR code received from the mobile terminal 2 against authentication information previously stored in the storage unit 106.

The data converter 110 converts into a QR code setting information set upon job execution and stored in a memory of the controller 105. In this case, if authentication information has been inputted by the user, this information is also included in the conversion into the QR code. In addition, if a public key is also provided from the mobile terminal 2, the conversion is performed in a manner encoded by the public key.

The data analyzer 111 analyzes a QR code read from the mobile terminal 2 to extract job setting information, authentication information, and the like included in the QR code.

The QR code reader 112 reads a QR code displayed on the mobile terminal 2. The QR code may be read by the scanner 101.

The mobile terminal 2 is composed of, for example, a mobile phone. Instead of a mobile phone, the mobile terminal 2 may be a PDA (Personal Digital Assistance), a laptop, or the like.

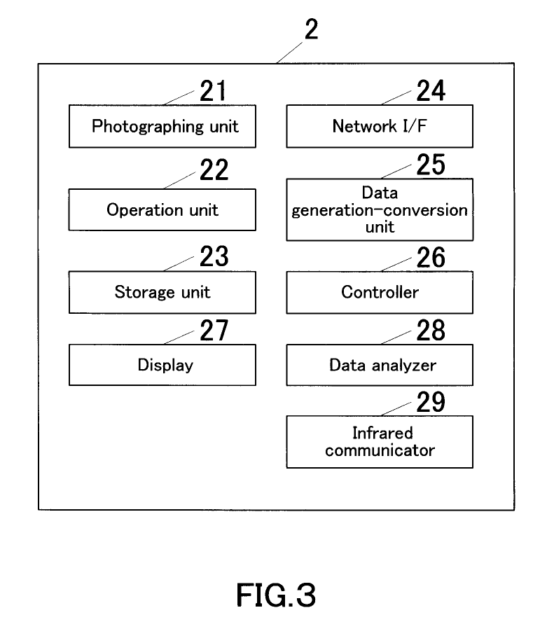

FIG. 3 is a block diagram showing the functional structure of main units of the mobile terminal 2.

The mobile terminal 2 includes: a photographing unit 21, an operation unit 22, a storage unit 23, a network interface 24, a data generation-conversion unit 25, a controller 26, a display 27, an infrared communicator 28, a data analyzer 29, and the like.

The photographing unit 21 includes a photographing camera and can photograph a QR code displayed on the display 104b of the image forming apparatus 1.

The operation unit 22 enables the user to operate the mobile terminal 2, and includes input keys and the like.

The storage unit 23 stores a QR code read from the image forming apparatus 1, application software downloaded from a predetermined address, a QR code analysis result, and the like.

The network interface 24 makes communication with an external apparatus via a network.

The data generation-conversion unit 25 creates a public key and a secret key for encoding setting information, authentication information, and the like concerning the image forming apparatus 1, which have been inputted by the mobile terminal 2, upon transfer of the aforementioned information to the image forming apparatus 1. The data generation-conversion unit 25 also converts the aforementioned setting information, authentication information, public key, and the like all together into a QR code.

The controller 26 comprehensively controls the entire mobile terminal 2, makes various determinations, and includes a CPU and memories such as a ROM, a RAM, and the like.

The display 27 displays a QR code displayed on the image forming apparatus 1 and then photographed by the photographing unit 21, a QR code obtained through conversion performed by the data generation-conversion unit 25, and other data.

The data analyzer 28 analyzes a QR code displayed on the image forming apparatus 1 and then photographed by the photographing unit 21 to extract setting information, authentication information, and the like included in the QR code.

The infrared communicator 29 transmits setting information, authentication information, and the like extracted by the data analyzer 28 to the image forming apparatus 1 through infrared communication with the image forming apparatus 1 in order to cause the image forming apparatus 1 to execute a job by use of the setting information, authentication information, and the like.

Next, referring to a flowchart of FIG. 5, a description will be given on the operation of the network image forming system shown in FIG. 1.

In step S11, to use the image forming apparatus 1, the user inputs an ID and a password as authentication information. The image forming apparatus 1 then performs authentication based on the inputted authentication information. If the authentication succeeds, the image forming apparatus 1 becomes ready for use. In step S12, job settings for the mode, the resolution, the number of copies, whether color or monochrome output, and the like are made so that the image forming apparatus 1 executes a job.

After the job execution, in step S13, the image forming apparatus 1 converts the setting information into a QR code. In this conversion, included in the QR code is a storage location URL (Uniform Resource Locator) of remote control application software required for transmitting through infrared communication the setting information included in the QR code.

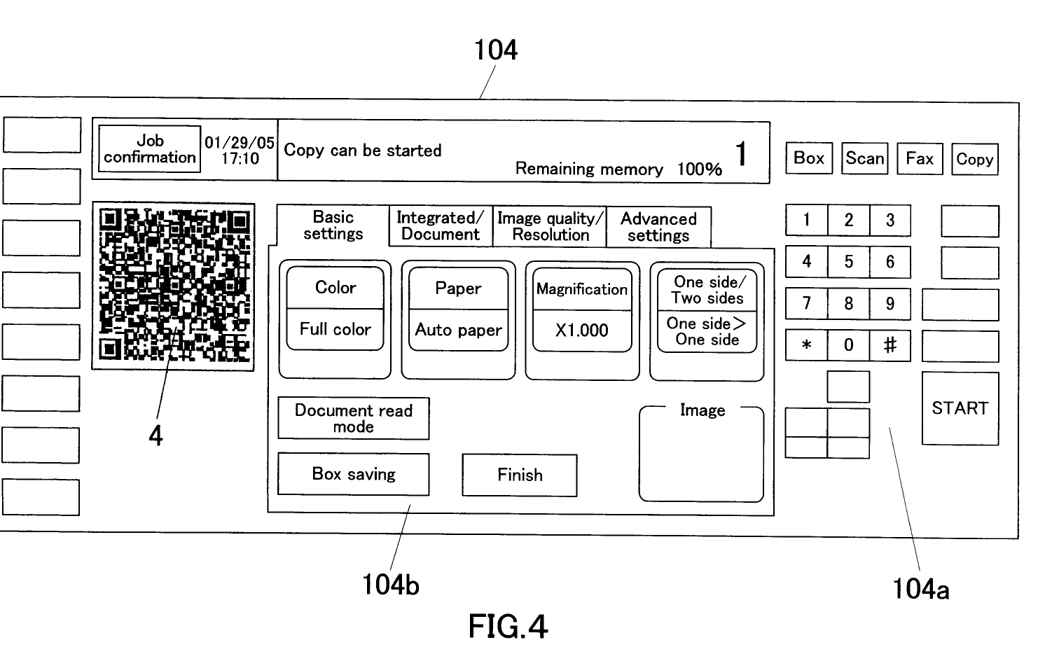

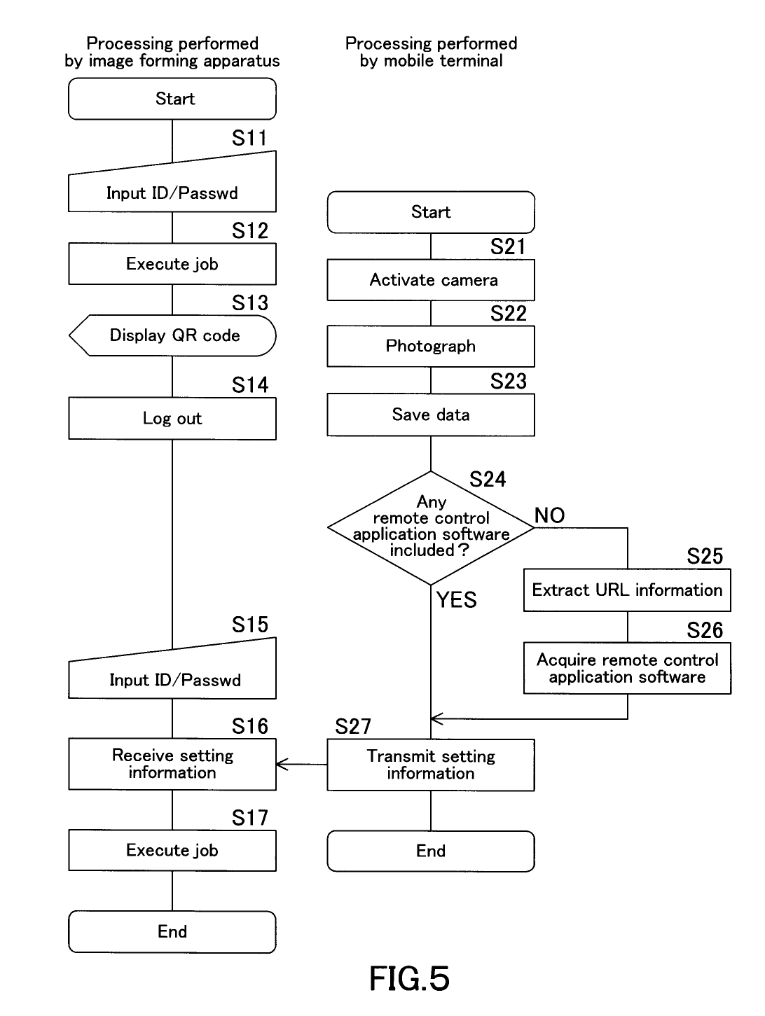

When the user presses a predetermined switch on the operation panel 104, as shown in FIG. 4, a QR code 4 is displayed on the display 104b of the operation panel 104, and then the image forming apparatus 1 logs out in step S21.

Meanwhile, in step S21, the user activates the camera included in the photographing unit 21 of the mobile terminal 2. Then, in step S22, the mobile terminal 2 photographs the QR code displayed on the display 104b, and, in step S23, saves the photographed QR code into the storage unit 23.

This saved QR code is used thereafter upon job execution done by the image forming apparatus 1 which has executed the job described above, or a different image forming apparatus 1.

Upon the job execution, in step S24, the mobile terminal 2 determines whether or not it includes remote control application software required for transmitting through infrared communication the setting information included in the QR code. If the mobile terminal 2 includes the remote control application software (i.e., the determination in step S24 is YES), the processing proceeds to step S27.

If the mobile terminal 2 includes no remote control application software (i.e., the determination in step S24 is NO), the mobile terminal 2 extracts the storage location URL of the application software from the QR code in step 25 and accesses the URL to acquire the remote control application software in step 26. Then the processing proceeds to step S27.

In step S27, by executing the application software, the mobile terminal 2 transmits the setting information included in the QR code to the image forming apparatus 1 via the infrared communicator 29, and then ends its processing. Before this transmission, in step S15, the user needs to input the authentication information into the image forming apparatus 1 to achieve authentication.

If the authentication succeeds, the image forming apparatus becomes ready for use. In step S16, the image forming apparatus receives the transmitted setting information via the infrared communicator 108, and then, in step S17, executes the job in accordance with the received setting information, and then ends its processing. The received setting information is identical to the setting information of the last job executed; therefore, the same job as the last one is executed.

In this way, a QR code displayed on the image forming apparatus which has executed a job can be photographed by the mobile terminal 2 to thereby transfer the job setting information to the mobile terminal 2 through a QR code, and thereafter, upon job execution, this job setting information can be transferred from the mobile terminal 2 to the image forming apparatus, so that job execution can be achieved based on this setting information. Therefore, once setting information is saved into the mobile terminal, the user is no longer required to input setting information by use of the operation panel 104 upon subsequent job executions.

Moreover, even when a change or an addition is made to the setting contents upon job execution, the change or addition to the setting contents is reflected on a QR code displayed after the job execution. Thus, simply photographing this QR code by the mobile terminal 2 permits a change or an addition made to setting contents to be reflected on subsequent job executions, which provides extremely great convenience.

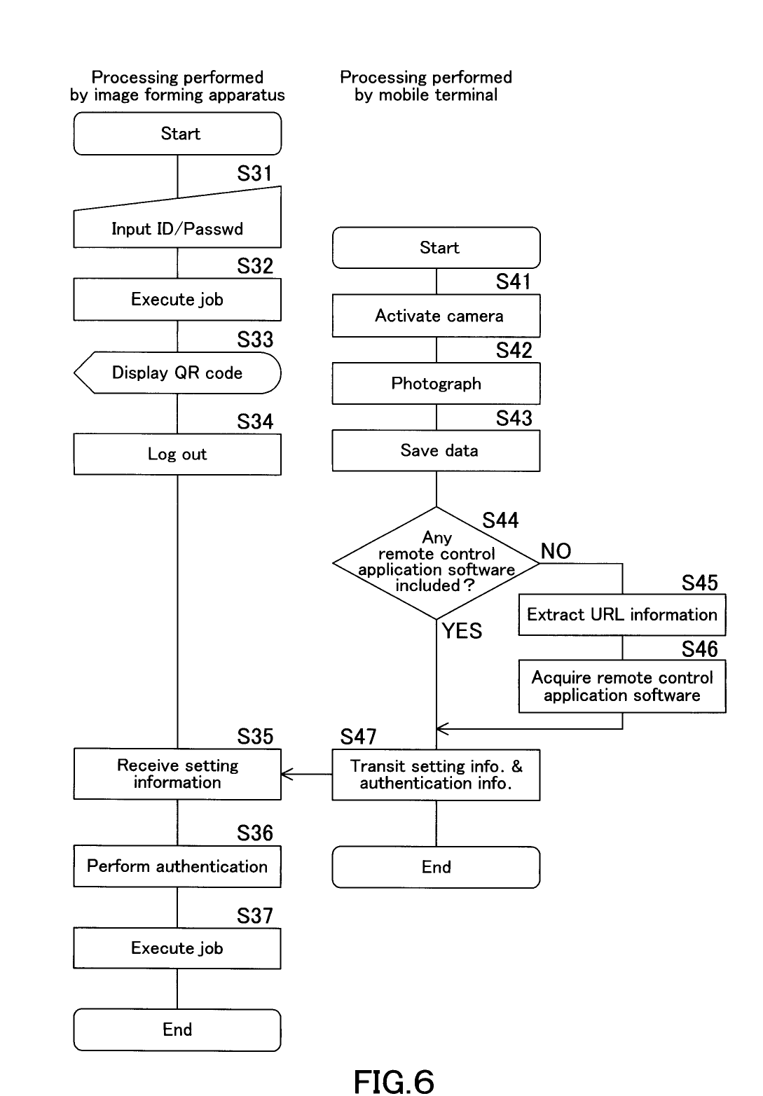

FIG. 6 is a flowchart showing the operation of the image forming system shown in FIG. 1 according to another embodiment of the present invention.

In this embodiment, a QR code obtained through conversion performed by the image forming apparatus 1 is transferred to the mobile terminal 2, including authentication information in addition to setting information, so that, upon subsequent job executions, user authentication is performed by use of the authentication information transferred together with the setting information from the mobile terminal 2 to the image forming apparatus 1.

In step S31, to use the image forming apparatus 1, the user inputs an ID and a password as authentication information, upon which the image forming apparatus 1 performs authentication. If the authentication succeeds, the image forming apparatus 1 becomes ready for use. In step S32, job settings for the mode, the resolution, the number of copies, whether color or monochrome output, and the like are made so that the image forming apparatus 1 executes a job.

After the job execution, in step S33, the image forming apparatus 1 converts the setting information and the authentication information inputted by the user into a QR code. In this conversion, included in the QR code is a storage location URL of remote control application software required for transmitting through infrared communication the setting information included in the QR code.

When the user presses the predetermined switch on the operation panel 104, as shown in FIG. 4, a QR code 4 is displayed on the display 104b of the operation panel 104, and then the image forming apparatus logs out in step S34.

Meanwhile, in step S41, the user activates the camera included in the photographing unit 21 of the mobile terminal 2. In step S42, the mobile terminal 2 then photographs the QR code 4 displayed on the display 104b, and, in step S43, saves the photographed QR code into the storage unit 23.

This saved QR code is used thereafter upon job execution done by the image forming apparatus 1 which has executed the job described above, or a different image forming apparatus 1.

Upon the job execution, in step S44, the mobile terminal 2 determines whether or not it includes remote control application software required for transmitting through infrared communication the setting information included in the QR code. If the mobile terminal 2 includes remote control application software (i.e., the determination in step S44 is YES), the processing proceeds to step S47.

If the mobile terminal 2 has no remote control application software (i.e., the determination in step S44 is NO), in step S45, the mobile terminal 2 extracts the storage location URL of the application software from the QR code, and, in step S46, accesses the URL to acquire the remote control application software. Then the processing proceeds to step S47.

In step S47, by executing the application software, the mobile terminal 2 transmits the setting information and the authentication information included in the QR code to the image forming apparatus 1 via the infrared communicator 29, and then ends its processing.

The image forming apparatus 1, in step S35, receives the transmitted setting information and authentication information via the infrared communicator 108, and, in step S36, performs user authentication by use of the transmitted authentication information.

If the authentication succeeds, in step 37, the image forming apparatus 1 executes the job in accordance with the received setting information, and then ends its processing. The received setting information is identical to the setting information of the last job executed; therefore, the same job as the last one is executed.

In this way, in this embodiment, authentication information initially inputted by the user is included, together with setting information, in a QR code, so as to be used as authentication information upon subsequent job executions. Therefore, the user is no longer required to input authentication information through the operation panel.

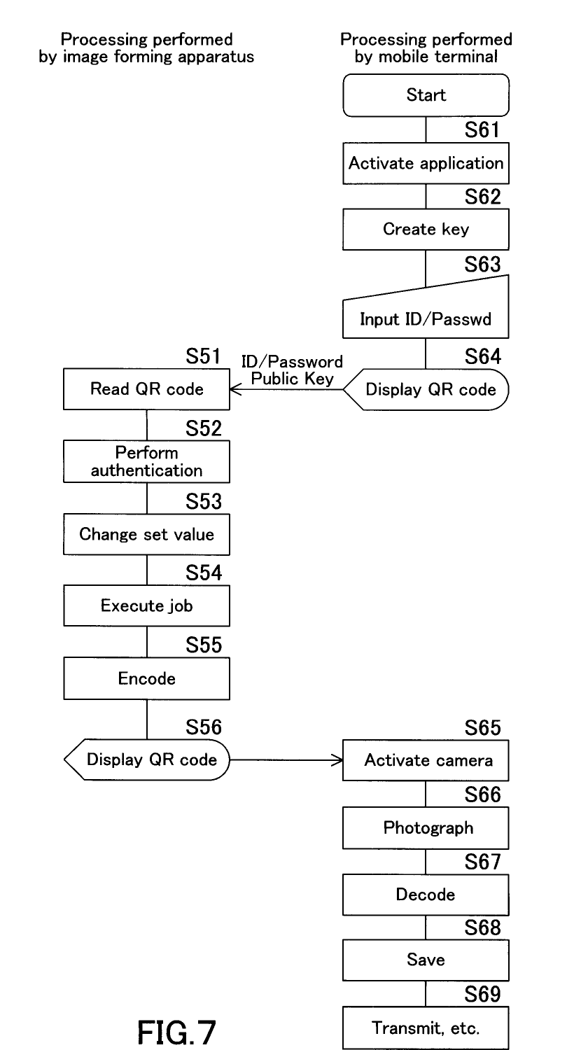

FIG. 7 is a flowchart showing the operation of the image forming system shown in FIG. 1 according to still another embodiment.

In this embodiment, authentication information and setting information are previously inputted into the mobile terminal 2, and these information together with a public key for encoding are converted into a QR code, which is then transferred to the image forming apparatus 1. Then, the image forming apparatus 1 performs user authentication based on the authentication information included in the QR code, and then, after job execution, transfers to the mobile terminal 2 the setting information in the form of a QR code in a manner encoded by the public key.

First, in step S61, the mobile terminal 2 activates application software for setting authentication information, setting a job, and creating an encoding key, and the like. If this application software is not included in the mobile terminal 2, the mobile terminal 2 acquires the application software from a predetermined address.

Next, in step S62, the mobile terminal 2 creates a public key and a secret key therein. As the source of a key, what cannot easily be predicted, such as the phone number, the serial number of the mobile terminal, time, and the like, may be used.

Subsequently, in step S63, authentication information such as an ID and a password, and setting information are inputted by the use of the operation unit 22. In step S64, the mobile terminal 2 converts the inputted information into a QR code and then displays it on the display 27.

In step S51, the image forming apparatus 1 reads the QR code displayed on the mobile terminal 2. This reading may be achieved by using either the QR code reader 112 or the scanner 101.

Next, in step S52, the image forming apparatus 1 performs user authentication by use of the authentication information included in the read QR code. The setting information included in the QR code is used for job setting. In step S53, the set value is changed if necessary, and then, in step S54, the image forming apparatus 1 executes the job.

Subsequently, in step S55, the image forming apparatus 1 converts the setting information into a QR code while encoding the information by the public key, and then, in step S56, the image forming apparatus 1 displays the QR code obtained through the conversion on the display 104 of the operation panel 104.

In step S65, the user activates the camera included in the photographing unit 21 of the mobile terminal 2. The mobile terminal 2 photographs the QR code 4 displayed on the display 104b in step S66, decodes the QR code by the secret key in step S67, and then saves it into the storage unit 23 in step S68. Then, in step S69, the mobile terminal 2 transmits the saved data to a specified destination by the use of a browser provided in the mobile phone, or displays on the display 27 thereof a QR code indicating address information on the aforementioned destination, and makes another image forming apparatus 1 to read it so that the saved data obtained from the destination is printed.

In this way, in this embodiment, authentication information is previously included in a QR code created by the mobile terminal 2. Therefore, the user is no longer required to input authentication information into the image forming apparatus 1 upon initial job execution, which provides great convenience.

Moreover, setting information in the image forming apparatus 1 is encoded by the public key and then converted into a QR code. Therefore, even when the setting information includes confidential information such as data destination and data saving destination, these setting information can be transferred without being read by others, thus maintaining a high level of security.

The present invention has been described, referring to the embodiments described above. However, the invention is not limited to these embodiments.

For example, the embodiments shown in FIGS. 5 and 6 refer to the case where setting information saved in the mobile terminal 2 is transferred to the image forming apparatus 1 through infrared communication. Alternatively, a QR code received from the image forming apparatus can be read directly by the image forming apparatus upon subsequent job executions.

Further, the display 104b of the image forming apparatus 1 displays a QR code so that the mobile terminal 2 photographs the displayed QR code. Alternatively, the printer 102 of the image forming apparatus 1 may print the QR code onto paper so that the mobile terminal 2 photographs the printed QR code.

Furthermore, setting information and authentication information are converted into a QR code. Alternatively, these information may be converted into another two-dimensional code, such as PDF417, a Maxi code, a Data matrix, or the like. Moreover, instead of being converted into a two-dimensional code, these information may be converted into data that can be displayed as an image and that can be read.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An image forming system comprising an image forming apparatus and a mobile terminal,
wherein the image forming apparatus comprises: a converter for converting into image data setting information related to job execution; and an output unit for outputting the image data obtained by the conversion; and
wherein the mobile terminal comprises: a photographing unit for photographing the outputted image data; a storage unit for saving the photographed image data; and an output unit capable of outputting either one of the saved image data and setting information indicated by the image data.

2. The image forming system according to claim 1,
wherein the output unit of the image forming apparatus is either one of a display for displaying image data and a printer for printing image data onto paper.

3. The image forming system according to claim 1,
wherein the output unit of the mobile terminal is either one of a display for displaying image data and a transmitter capable of transmitting setting information included in image data.

4. The image forming system according to claim 1,
wherein the image data includes user authentication information.

5. The image forming system according to claim 1,
wherein the image data includes address information on a storage location of application software for transmitting setting information included in the image data saved by the mobile terminal.

6. The image forming system according to claim 1,
wherein the image data is encoded.

7. The image forming system according to claim 6,
wherein a secret key and a public key for encoding are created by the mobile terminal, which then converts data including the created public key into image data and outputs the image data.

8. The image forming system according to claim 1,
wherein the image data is a QR code.

9. An image forming apparatus comprising: a converter for converting into image data setting information related to job execution; and an output unit for outputting the converted image data.

10. The image forming apparatus according to claim 9,
wherein the output unit is either one of a display for displaying image data and a printer for printing image data onto paper.

11. The image forming apparatus according to claim 9,
wherein the image data includes user authentication information.

12. The image forming apparatus according to claim 9,
wherein the image data includes address information on a storage location of application software for transmitting setting information included in the image data saved by the mobile terminal.

13. The image forming apparatus according to claim 9,
wherein the image data is encoded.

14. The image forming apparatus according to claim 9,
wherein the image data is a QR code.

15. An image forming apparatus comprising:
a reading unit for reading image data that includes setting information related to job execution and that is outputted from a mobile terminal;
an analyzer for analyzing the read image data and extracting setting information; and
a job executor for executing a job based on the extracted setting information.

16. The image forming apparatus according to claim 15, further comprising a user authentication unit for performing user authentication based on authentication information which is included in the image data.

17. The image forming apparatus according to claim 15,
wherein the image data is encoded.

18. The image forming apparatus according to claim 15,
wherein the image data is a QR code.

19. A data processing method comprising the steps of:
converting setting information related to job execution into image data by an image forming apparatus;
outputting the converted image data from the image forming apparatus;
photographing the outputted image data by a mobile terminal;
saving the photographed image data by the mobile terminal;
outputting either one of the saved image data and setting information indicated by the image data from the mobile terminal;
receiving either one of the outputted image data and the setting information by the image forming apparatus; and
executing a job based on either one of setting information extracted by analyzing the received image data and the received setting information by the image forming apparatus.
